(19) United States
(12) Patent Application Publication
(10) Pub. No.: US 2004/0066085 A1
(43) Pub. Date: Apr. 8, 2004

(54) One-piece composite rim

(76) Inventor: Jason Schiers, Midvale, UT (US)

Correspondence Address: Dana Alden, MacLean-Fogg Company, 1000 Allanson Road, Mundelein, IL, 60060, US

(21) Appl. No.: 10/264,765

(22) Filed: Oct. 5, 2002

(51) Int. Cl. B60B 21/00

(52) U.S. Cl. 301/95.102

(57) ABSTRACT

The present invention relates to a composite rim, comprising a tire-accommodating surface located between a first outer surface and a second outer surface wherein the tire accommodating surface is curved, an annulus-defining surface located between a third outer surface and a fourth outer surface wherein the annulus-defining surface accepts a spoke; and the tire-accommodating surface, the annulus-defining surface, and the outer surfaces enclose a cavity.

### FIELD OF THE INVENTION

This invention relates to rims, and particularly to composite rims used in wheels for bicycles.

### BACKGROUND OF THE INVENTION

Composite rims are known in the art. An example of such a rim is shown in U.S. Pat. No. 6,398,313, the disclosure of which is hereby incorporated herein by reference. While the rim disclosed in U.S. Pat. No. 6,398,313 is adequate, it is of a two-piece design which requires more time and labor in fabrication.

The present invention is directed to overcoming this and other disadvantages inherent in prior-art systems.

### SUMMARY OF THE INVENTION

The scope of the present invention is defined solely by the appended claims, and is not affected to any degree by the statements within this summary. Briefly stated, a composite rim, comprising a tire-accommodating surface located between a first outer surface and a second outer surface wherein the tire accommodating surface is curved, an annulus-defining surface located between a third outer surface and a fourth outer surface wherein the annulus-defining surface accepts a spoke; and the tire-accommodating surface, the annulus-defining surface, and the outer surfaces enclose a cavity.

### BRIEF DESCRIPTION OF THE DRAWINGS

FIG. 1 depicts a profile view of a preferred embodiment of one-piece composite rim.

FIG. 2 depicts a profile view of an alternative embodiment of a one-piece composite rim.

FIG. 3 depicts the mold used to fabricate the preferred embodiment.

FIG. 4 depicts the inner ring of the mold used to fabricate the preferred embodiment.

FIG. 5 depicts the outer ring of the mold used to fabricate the preferred embodiment.

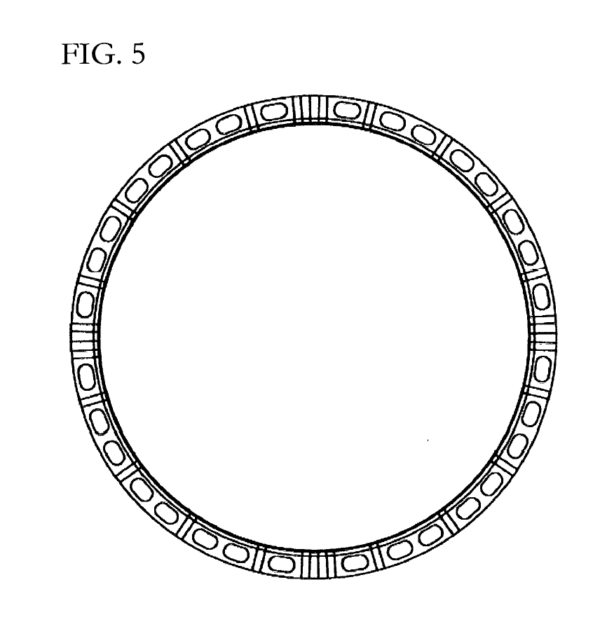

FIG. 6 depicts the inner ring assembled to the outer ring.

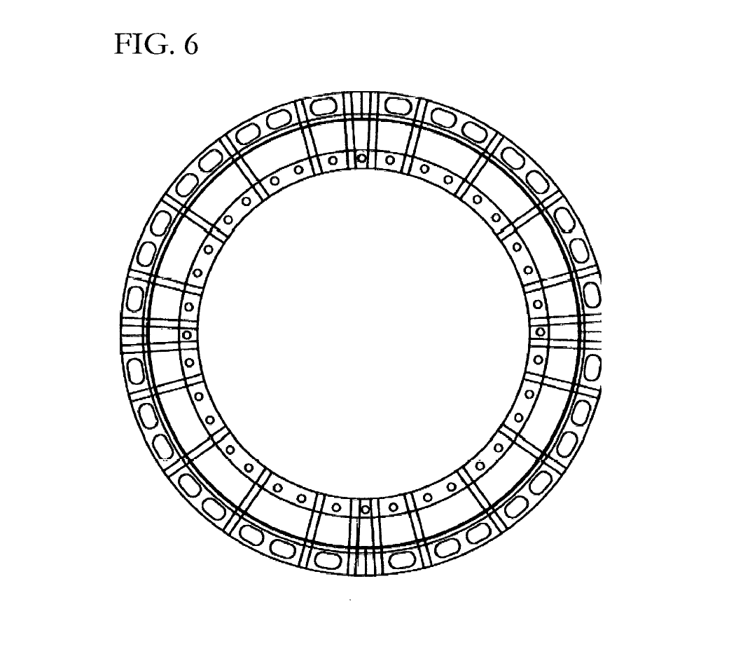

FIG. 7 depicts the rim located within the mold.

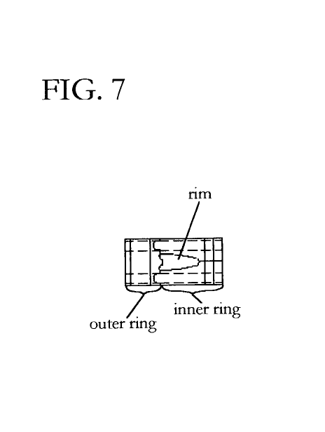

FIG. 8 depicts a completed rim with spokes and a hub.

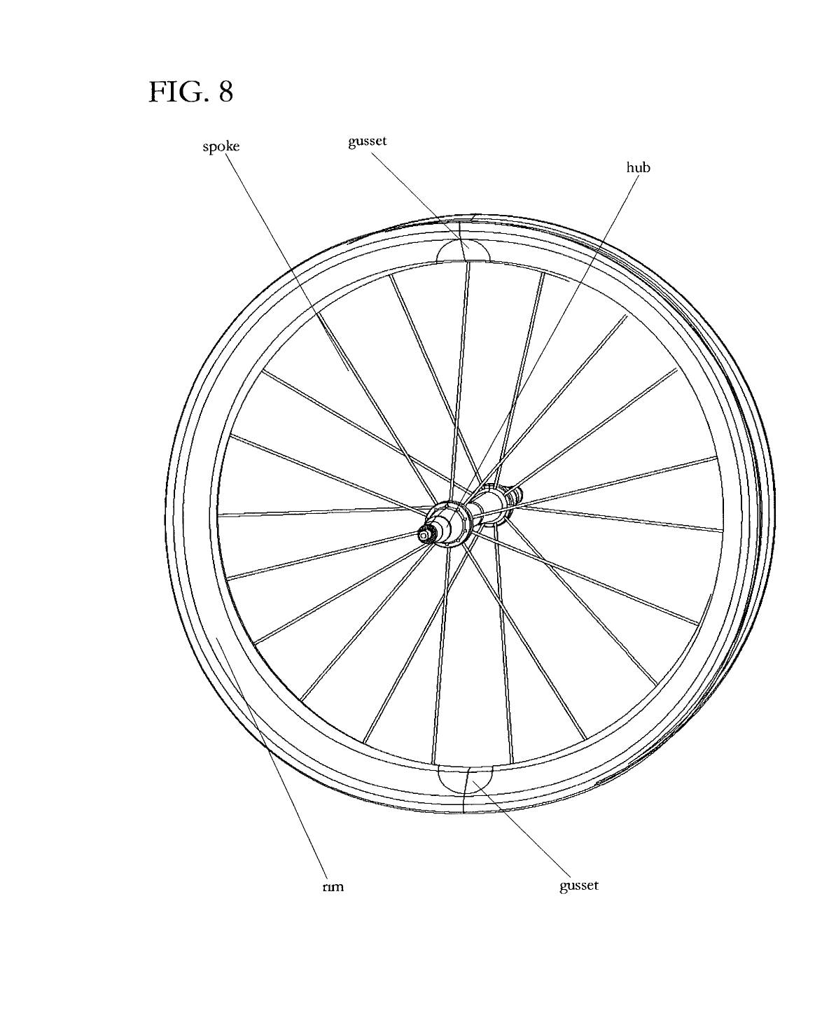

### DETAILED DESCRIPTION OF THE PRESENTLY PREFERRED EMBODIMENTS

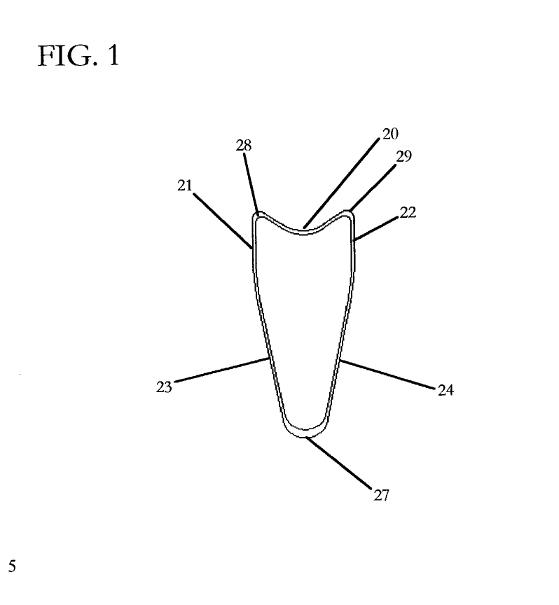

Turning now to the drawings, FIG. 1 depicts the profile of a rim 10 constituting a preferred embodiment of the present invention. The rim 10 is composed of a composite material. For the present invention, a composite material is any substance in the art that includes an organic compound, has sufficient strength to withstand the forces exerted by irregular surfaces during travel at high speeds, and is lighter per unit of volume than a metal or metal alloy. The rim 10 of the preferred embodiment is made from a composite material, preferably, a polymer. In another aspect of the present invention, the composite material is preferably a unidirectional polymer material.

According to one aspect of the present invention, the composite material is a chemical compound, such as an organic compound, which is lighter per unit of volume than a metal or metal alloy, and composed of a single material. According to one aspect of the present invention, the composite material is a resin. According to another aspect of the present invention, the composite material is a polymer. According to another aspect of the present invention, the composite material is a plastic, such as thermoplastic or thermoset. According to yet another aspect of the present invention, the composite material is a polyester. According to still yet another aspect of the present invention, the composite material is an epoxy.

The composite material of the present invention is in a plurality of chemical combinations. According to one aspect of the present invention, the composite material is a mixture. According to another aspect of the present invention, the composite material is a mixture of a polymer and reinforcing materials.

The reinforcing material is in a plurality of shapes and configurations. According to one aspect of the present invention, the reinforcing material is in the shape of beads. In one embodiment, the reinforcing material is beads of glass. According to another aspect of the present invention, the reinforcing material is in a fibrous shape. In one embodiment of the present invention, the reinforcing material is glass fiber. Those skilled in the art will appreciate that the reinforcing material is composed of beads and fibers, and that any combination thereof can be used.

In one embodiment of the present invention, the reinforcing material is glass. Those skilled in the art will appreciate that a composite material is a polymer mixed with glass. In another embodiment, the reinforcing material is an arimid. Those skilled in the art will also appreciate that a composite material is a polymer mixed with an aramid.

According to one aspect of the present invention, a composite material is a polymer mixed with polyester. According to another aspect of the present invention, the composite material is a polymer mixed with a resin. According to yet another aspect of the present invention, the composite material is a polymer mixed with a plastic. According to still another aspect of the present invention, the composite material is a polymer mixed with an epoxy.

The mixture is not limited to the above, and a composite material is not limited to the foregoing description. So long as the material is a substance that has includes an organic compound, has sufficient strength to withstand the forces exerted by irregular surfaces during travel at high speeds, and is lighter per unit of volume than a metal or metal alloy, it is a composite material within the scope of the present invention.

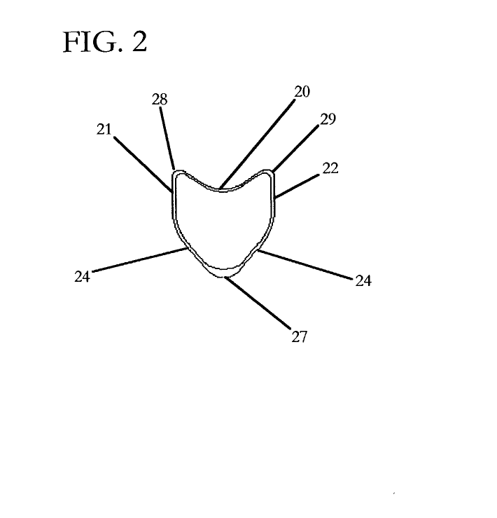

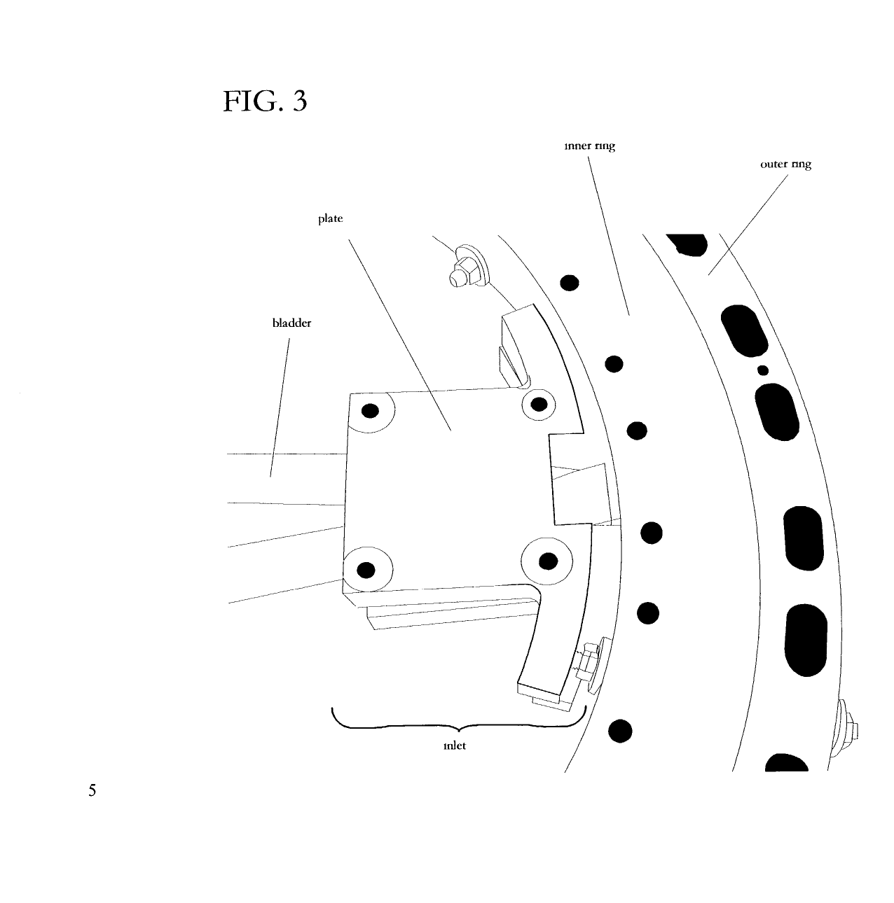

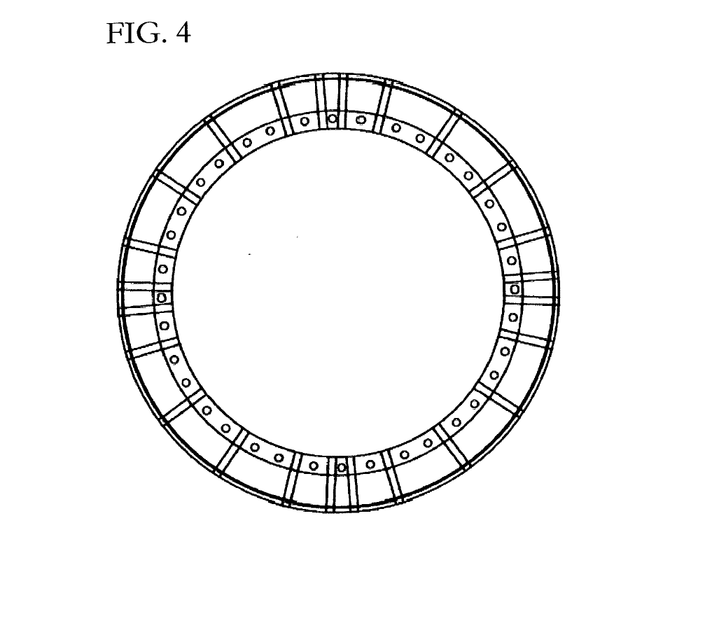

As depicted in FIGS. 1, 2, 3, and 4, the rim 10 of the preferred embodiment is in an annular shape and is made with a plurality of surfaces. FIG. 1 depicts a profile view of an embodiment of the present invention. As shown in FIG. 1, the rim 10 is provided with a tire-accommodating surface 20. At least a portion of the tire-accommodating surface 20 is configured to be in contact with at least a portion of the surface of a tire 70. In the embodiment depicted in FIG. 1, the tire-accommodating surface 20 is curved. Preferably, the curve is an arc of between 60 and 180 degrees.

The tire-accommodating surface 20 is located between a first outer surface 21 and a second outer surface 22. Preferably, the tire-accommodating surface 20 and the first outer surface 21 abut one another to form a first ridge 25. In similar fashion, the second outer surface 22 preferably abuts the tire-accommodating surface 20 to form a second ridge 26. As shown in the embodiment depicted in FIG. 1, the first outer surface 21 opposes the second outer surface 22. Preferably, the first outer surface 21 is parallel to the second outer surface 22. In the preferred embodiment, the first outer surface 21 and the second outer surface 22 may advantageously function to provide a braking area. Those skilled in the art will appreciate that the first outer surface 21 and the second outer surface 22 may be further reinforced in glass or a plastic material.

Adjacent to the first outer surface 21 is a third outer surface 23. The third outer surface 23 is configured to be at an angle relative to the first outer surface 21. This configuration is preferably accomplished via a first smooth surface 28. However, those skilled in the art will appreciate that the third outer surface 23 can be at an angle relative to the first outer surface 21 via a sharply angled configuration. Adjacent to the second outer surface 22 is a fourth outer surface 24. The fourth outer surface 24 is configured to be at an angle relative to the second outer surface 22. This configuration is preferably accomplished via a second smooth surface 29. However, those skilled in the art will appreciate that the fourth outer surface 24 can be at an angle relative to the second outer surface 22 via a sharply angled configuration. Preferably, the third outer surface 23 is at an angle relative to the fourth outer surface 24 of between 20 and 90 degrees.

Adjacent to and located between the third outer surface 23 and the fourth outer surface 24 is an annulus-defining surface 27. The annulus-defining surface 27 is curved, preferably having an arc between 60 and 180 degrees, and, as depicted in FIG. 1, preferably thicket than the third outer surface 23 or the fourth outer surface 24. However, those skilled in the art will appreciate that the annulus-defining surface 27 may be the of the same thickness as the third outer surface 23 or the fourth outer surface 24 without departing from the scope of the present invention.

The tire-accommodating surface 20, the first outer surface 21, the second outer surface 22, the third outer surface 23, the fourth outer surface 24, and the annulus-defining surface 27 enclose a cavity 30. In the preferred embodiment, the cavity is empty. However, those skilled in the art may advantageously fill the cavity with foam or structural material.

The presently preferred embodiment is fabricated through molding, preferably through bladder molding. However, those skilled in the art will appreciate that other molding techniques may be employed. According to one aspect of the present invention, the rim 10 is fabricated through injection molding. According to another aspect of the present invention, the rim 10 is fabricated through transfer molding. According to yet another aspect of the present invention, the rim 10 is fabricated through compression molding. According to still another aspect of the present invention, the rim 10 is fabricated through vacuum bag molding. According to still yet another aspect of the present invention, the rim 10 is fabricated through machining. Those skilled in the art will appreciate that other molding techniques may be employed without departing from the scope or spirit of the present invention.

The preferred embodiment of the present invention is fabricated in a mold. The presently preferred mold is composed of a plurality of components. The preferred embodiment is fabricated in a three piece mold. An outer ring, an inner ring, and an inlet body. The composite material is placed within the inner ring. A bladder is employed so that the composite material is between the bladder and the inner ring.

The bladder is a tube composed of an elastomer material and is of sufficient length so that it is longer than the circumference of the rim 10. The bladder is placed inside the composite material so that the ends are outside mold while the remaining portion of the bladder is in contact with the composite material. The outer ring is placed over the composite material, the bladder, and the inner ring. The mold is then placed in an oven and the bladder is inflated via the inlet.

The inlet is provided with a first plate and a second plate. Holes for a plurality of fasteners are defined within the plates so that the first plate and the second plate are fastened together compressing the bladder which is disposed thereinbetween. The inlet body is fixed to the mold via a fastener. The bladder is connected to a pressured line so that a gas or a liquid is pumped into the bladder while the mold is being heated and the composite material is being cured.

After the composite material is cured, the mold is removed from the oven, and the rim is removed from the mold. The bladder is removed from the rim via an opening in the composite material. Then a gusset or patch is used to cover the opening. The gusset used on the preferred embodiment is in the shape of a disc; however, those skilled the art will appreciate that any shape may be employed. After the gusset or patch is affixed to the rim, the rim may advantageously be provided with a sanded finished.

After the rim is finished, holes to accommodate a plurality of spokes are drilled in the rim by methods known in the art. The preferred embodiment is configured to accommodate as few as 2 spokes and as many as 36 spokes via methods well known in the art (e.g. a threaded nipple). Furthermore, the preferred embodiment is configured to withstand high spoke tensions (e.g. exceeding 1800 newtons) that would pull through an aluminum rim.

The spokes are composed of a plurality of materials. According to one aspect of the present invention, the spokes are composed of a metal. According to another aspect of the present invention, the spokes are composed of an alloy. According to yet another aspect of the present invention, the spokes are composed of a composite material.

The spokes are advantageously angled relative to a radius of the rim. However, those skilled the art will appreciate that the spokes need not be angled in order for the present invention to operate. In the preferred embodiment, the spokes are at a 6 degree angle relative to a radius of the rim. In another embodiment, the spokes are at a 5 degree angle relative to a radius of the rim. In yet another embodiment, the spokes are at between 1 and 2 degrees relative to a radius of the rim.

While this invention has been particularly shown and described with references to preferred embodiments thereof, it will be understood by those skilled in the art that various changes in form and details may be made therein without departing from the spirit and scope of the invention as defined by the appended claims.

What is claimed is:

1. A rim composed of a composite material, comprising:
a) a tire-accommodating surface located between a first outer surface and a second outer surface wherein the tire accommodating surface is curved;
b) an annulus-defining surface located between a third outer surface and a fourth outer surface wherein the annulus-defining surface accepts a spoke; and
c) the tire-accommodating surface, the annulus-defining surface, and the outer surfaces enclose a cavity.

2. A rim according to claim 1, wherein the first outer surface and the second outer surface provide a braking surface.

3. A rim according to claim 1, wherein the rim is formed of one piece.

4. A rim according to claim 1, wherein the rim is formed in a mold.

5. A rim according to claim 1, wherein the rim is formed of a uni-directional material.
